(19) United States
(12) Patent Application Publication
(10) Pub. No.: US 2023/0170139 A1
(43) Pub. Date: Jun. 1, 2023

(54) Method and Apparatus for The Vertical Plating of Magnetic Cores

(71) Applicant: Atlas Magnetics Inc., Reno, NV (US)

(72) Inventor: John Othniel McDonald, Reno, NV (US)

(21) Appl. No.: 18/072,692

(22) Filed: Nov. 30, 2022

Related U.S. Application Data
(60) Provisional application No. 63/284,502, filed on Nov. 30, 2021.

(51) Int. Cl. H01F 41/02; C25D 5/00; C25D 5/22

(52) U.S. Cl. CPC H01F 41/0206; C25D 5/009; C25D 5/22

(57) ABSTRACT

A method of producing layered cores for magnetic circuit components such as inductors and transformers suitable for use in the microelectronics industry. A series of pillars are created on a carrier Layers of the magnetic core are plated onto the exposed surface of the pillars. After the desired number of core layers are plated, the plated layers are ground down to expose the pillars, leaving a series of magnetic cores between the pillars. The pillars can then be removed, leaving a series of magnetic cores. The pillars are created by either building up pillars, such as copper pillars, or by slitting plastic mediums, such as dry film or epoxy plastic, the roughness of the magnetic cores produced depends on the method of forming the pillars.

### BACKGROUND

The general field of the present invention relates to methods and apparatuses for electroplating vertically; more specifically, the field of the present invention relates to the utilization of vertical electroplating in magnetic core production.

Electroplating is a method of plating used in electrical component manufacturing. It involves the layering of metal to build layered components such as magnetic cores. There are no accurate, low-cost, high-volume methods for producing the smallest components necessary for circuitry, and electrical components continue to downsize. Instead, expensive and specialized plating equipment is used to produce the smallest components. Further, even as electrical components continue to downsize, more and more objects are incorporating electrical components—increasing the demand for large-scale production of cheap small electrical components.

Electroplating in the semiconductor industry can be performed horizontally, wherein layers are plated parallel to and on the wafer. Horizontal plating does not reference the particular orientation of the wafer itself, so a wafer may be placed vertically in a plating bath and still be horizontally plated. Horizontal plating is the traditional method of electroplating.

However, horizontal plating methods struggle to produce at industrial volumes the small components necessary for circuitry as electrical components continue to downsize. The limitations of horizontal plating are becoming more evident since even as electrical components continue to downsize, more and more objects are incorporating electrical components—increasing the demand for large-scale production of cheap small electrical components.

One attempt to overcome the limitations of horizontal plating is vertical plating. Vertical plating occurs when a material is plated in an orientation perpendicular to the semiconductor device or wafer. This is hard to achieve in practice, especially at low cost and for a thin magnetic core; for instance, one method calls for front and back etching of a semiconductor wafer to form through cuts which are then plated with nickel-iron while leaving an air-gap in-between each nickel-iron layer. The resulting core was a “pattern of Ni—Fe:Si:Ni—Fe:Air” that was bulky and incorporated unnecessary materials for a magnetic core. This method of production was also limited to the silicon substrate. Further, as a result of each slit being created by a back and front etching process, the slits were often misaligned, causing a disjunction in the alignment of the nickel-iron layers and the resulting layers were bulky.

Therefore, vertical plating needs to be refined to remove unnecessary materials, reduce the size of the cores, and produce a straighter core.

The following United States patents are incorporated by reference:

US20040164839A1: Magnetic inductor core and inductor and methods for manufacturing same

U.S. Pat. No. 7,140,092 B2: Methods for manufacturing inductor cores

The following research papers are incorporated by reference in full:

Arnold, David P., et al. “Vertically laminated magnetic cores by electroplating Ni—Fe into micromachined Si.” IEEE transactions on magnetics 40.4 (2004): 3060-3062.

Park, Jin-Woo, Florent Cros, and Mark G. Allen. “A sacrificial layer approach to highly laminated magnetic cores.” Technical Digest. MEMS 2002 IEEE International Conference. Fifteenth IEEE International Conference on Micro Electro Mechanical Systems (Cat. No. 02CH37266). IEEE, 2002.

### BRIEF SUMMARY OF THE INVENTION

The present invention provides methods for vertical electroplating, where the core material is plated perpendicular to the semiconductor wafer or device, material unnecessary to the core function is eliminated, and straight core layers are produced. This method is achieved by a combination of modified horizontal plating, vertical plating, and grinding.

This invention enables the large, cost-effective commercial production of small layered magnetic cores by providing a means to electroplate small layers. In at least one exemplary embodiment, a series of pillars are created on the surface of a carrier, the pillars of the series having a height equal to the width of a magnetic core to be formed and being spaced according to the height of the magnetic core to be formed; at least one core layer on the upper and side surfaces of the pillars in the series is plated, and The core layers on the upper surface of the pillars are ground off to form a series of cores.

As two layers of each core are simultaneously plated, the time to plate the metal cores is cut in half. As pillars are used, there is no need to align through cuts in a medium or to stitch a core together afterward.

Further, as noted above, once the layers are formed, the layers will be ground down to expose the pillars and all layers of the magnetic core. This step enables the use of pillars in the method. It is this step, in conjunction with pillar use, that therefore enables this method to be cheaply reproduced on an industrial scale. The grinding process is important because, in the plating process, layers will plate on the top of the pillars as well as on the sides of the pillars. So, grinding down to expose the pillars will expose the sides of the layers as well. Once ground down, the pillar can be removed, and the created cores processed. This doubles the speed of plating small cores and thus lowers the cost of plating the cores at scale.

In at least one exemplary embodiment of the present invention, a dry film is placed onto the semiconductor wafer, and a series of slits are created in the dry film by positive or negative means. The dry film has a range of thicknesses and is generally in the range of 5 to 100 microns. The film may be applied through a spin-on process where a liquid is deposited on the surface of the wafer, which is then spun to spread out the liquid. Once spread out, the liquid is baked, which turns it solid.

The slits do not enter the semiconductor wafer but are limited to the initial medium of dry film. This process creates a series of dry film pillars. Because dry film undergoes a light-based process to produce the patterned slits, the sides of the pillars are extremely straight. These pillar sides will serve as a base for the magnetic material of the core, such as nickel-iron, providing a straight magnetic core layer.

Magnetic cores may be formed by electroless plating or electroplating, or a combination of the two plating styles. Electroless plating occurs through an autocatalytic chemical reduction of metal cations in a bath. So, that metal is plated onto an object in the bath by an automatic chemical reaction. This may be slower than plating by electroplating, which occurs when an anion and cation are placed into a special bath. Here an electric current is run through the bath, which drives a chemical reaction that pulls metal ions from the anode and plates them onto the anode. However, electroless plating can often provide a seed layer that enables electroplating to occur.

Once the pillars are formed, a first core layer is plated over the dry film. By design, the core layer is plated on the top and sides of the dry film. Any additional layers will form on the first core layer surface and continue to sit on the top and sides of the dry film. The resulting structure appears as a series of connecting magnetic core T shapes covering the dry film. These T shapes are ground down until the dry film under the bar of the T is exposed, leaving the magnetic core material plated on the sides of the dry film in a straight “I” shape. The dry film can then be removed or preserved for a later purpose.

This style of vertical plating can also be done in plastic, where, for example, epoxy plastic is patterned by chemical etching or laser drilling to create plastic pillars. Therefore, embodiments can be described as methods where a series of pillars are created in a medium, magnetic core layers are plated onto the pillared medium, and the resulting structure is ground to produce a series of magnetic cores above the plating wafer or carrier.

This method creates straighter cores with improved performance over disjointed cores while allowing the magnetic cores to be incorporated into more semiconductor products in various ways beyond what could be achieved with pure incorporation of the core into the silicon substrate.

Because vertical plating in this manner plates on two opposite surfaces of a slit, the gap between two pillars, at one single time, laminated magnetic cores can be plated twice as fast compared to horizontal plating with the same manufacturing precision as horizontal plating. This speed is due to the fact that two laminated core layers are always plated simultaneously. This allows for low-cost scaling as the time to produce the cores is reduced. Further, the size of the magnetic cores plated by this method is elegantly variable: controlled by altering the depth of the medium and the width of the slits in the medium.

### BRIEF DESCRIPTION OF THE FIGURES

FIG. 1A is a top-down view of a wafer.

FIG. 1B is a side view of a wafer.

FIG. 2 is a cross-sectional view of copper pillars on a semiconductor carrier.

FIG. 3 is a cross-sectional view of magnetic core layers plated on copper pillars.

FIG. 4 is a cross-sectional view of the structure of FIG. 2 ground down to present a level surface.

FIG. 5 is a cross-sectional view of the resulting magnetic cores on the semiconductor carrier.

FIG. 6 is a cross-sectional view of the resulting magnetic cores on the semiconductor carrier with the copper pillars left in place.

FIG. 7 is a cross-sectional view of a semiconductor carrier.

FIG. 8 is a cross-sectional view of a semiconductor carrier with a dry film.

FIG. 9 is a cross-sectional view of a dry film having a mask.

FIG. 10 is a cross-sectional view of a dry film with slits forming pillars.

FIG. 11 is a cross-sectional view of a dry film receiving an initial core layer.

FIG. 12 is a cross-sectional view of a dry film receiving multiple magnetic core layers.

FIG. 13 is a cross-sectional view of the structure of FIG. 11 ground down to present a level surface.

FIG. 14 is a cross-sectional view of a semiconductor carrier.

FIG. 15 is a cross-sectional view of a semiconductor carrier with a plastic deposit.

FIG. 16 is a cross-sectional view of a dry film with a chemical etching mask.

FIG. 17 is a cross-sectional view of epoxy plastic on a semiconductor carrier being laser drilled.

FIG. 18 is a cross-sectional view of an epoxy plastic having a series of slits.

FIG. 19 is a cross-sectional view of epoxy plastic receiving an initial core layer.

FIG. 20 is a cross-sectional view of an epoxy plastic receiving multiple magnetic core layers.

FIG. 21 is a cross-sectional view of the structure of FIG. 19 ground down to present a level surface.

FIG. 22 is a cross-sectional view of an apparatus of the present invention having a single layer.

### DETAILED DESCRIPTION

The present invention involves vertically plating magnetic cores for circuit components, including passives integrated into semiconductor packaging. Creating the magnetic core of the invention involves creating a series of pillars upon a core surface, plating at least one core layer into plating slits in-between the pillars, and then grinding away any excess material. The pillars may be created by placing a medium onto a wafer or device and creating plating slits in the medium or by building up pillars, typically copper, on the plating surface.

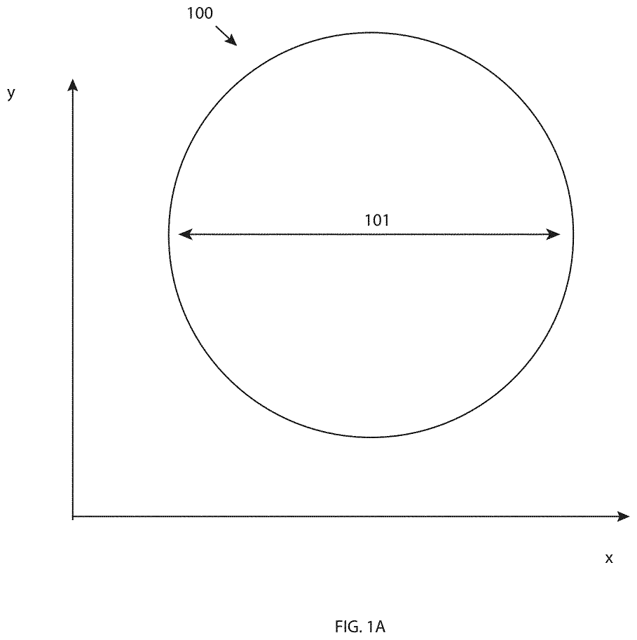

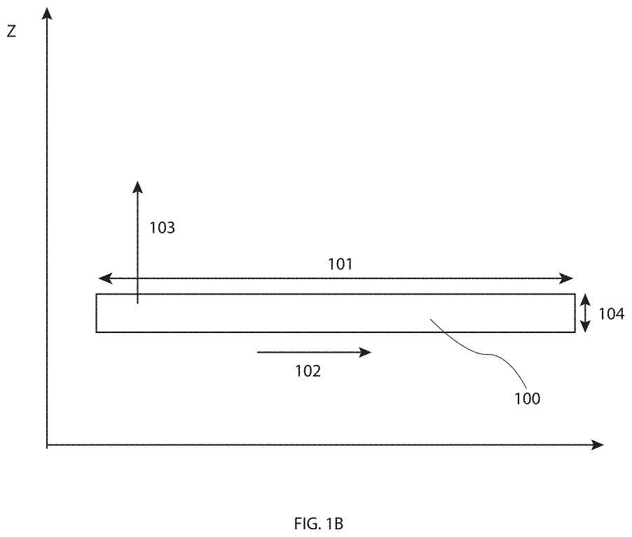

FIG. 1A and FIG. 1B demonstrate wafer orientation. FIG. 1A provides a top-down view of a flat silicon wafer 100 with diameter 101. Semiconductor wafers may vary by size and commonly are found with a diameter 101 of 4″, 6″, 8″, or 10″. FIG. 1B shows a side view of a silicon wafer 100 with diameter 101, horizontal dimension 102, and vertical dimension 103. The wafer thickness 104 is typically 300-500μ.

Therefore, in vertical plating, the magnetic core layers are built along the horizontal direction, while in horizontal plating, the layers are built up in the vertical direction. This is because, in vertical and horizontal plating, the directional reference is in according to their base layer direction. So, in vertical plating, a core is plated of a base that is vertical/perpendicular to the wafer, but in horizontal plating, the core is plated of a base layer that is parallel to the wafer.

In the preferred mode of the present invention, copper pillars are plated onto a plating surface. After the plating of pillars onto the surface, the layers of the magnetic core are built upon the sides of the pillars. The copper pillars may be spaced evenly apart.

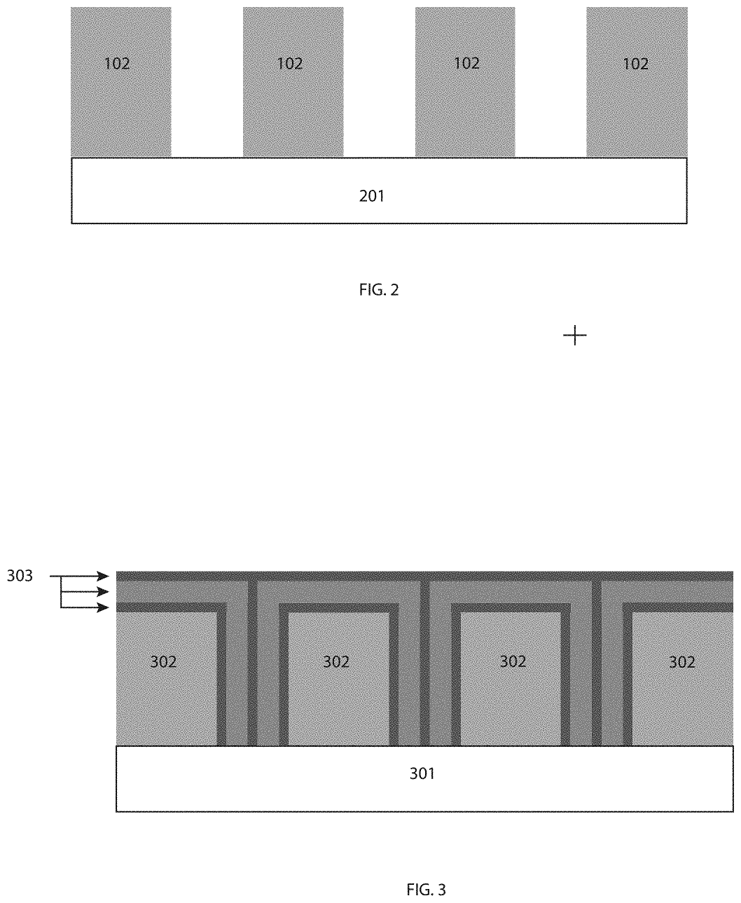

Therefore, as shown in FIG. 2, copper pillars, 202 are plated onto a surface such as silicon wafer 201. A series of at least two pillars are created and are spaced apart according to the desired vertical height of the core. The pillar height controls the width of the core so the pillars should be as tall or taller than the width of the core.

As shown in FIG. 3, magnetic core layers, 303 are plated onto the copper surfaces so that the magnetic core layers follow the contours of the copper. As such, a core will be created in between each copper pillar 302, sitting perpendicular to the original plating surface 301, being supported in the vertical position by the two pillars. Although discussed here in terms of copper, the pillars are not limited to copper material but may be another plateable material.

This placement of the pillars enables the core to be plated from the top-down and the bottom-up at once, making the plating process twice as fast as building the plate from one direction. This saves time and costs in the plating process. These layers can be very small, and the magnetic core can be very small as well, even as small or smaller than 15 nanometers from the top of the core to the bottom.

As shown in FIG. 4 the excess magnetic core layers rising above the top of the copper pillars are ground down so that all the core layers 403 and the pillars 402 themselves are exposed. This enables all the magnetic core layers to be accessible as well as allows access to any copper used in the building process, such as for pillars. This enables the etching out of the copper pillars 402.

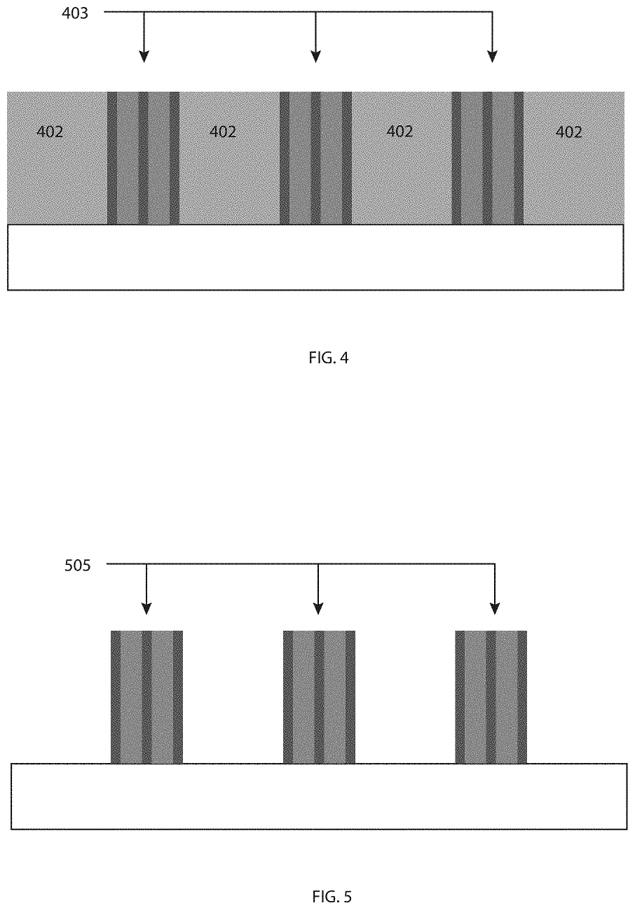

FIG. 5 shows the copper pillars etched out, leaving only magnetic cores 505. In some embodiments, the remaining space between the magnetic cores 505 may be filled. This may enable the creation of larger cores.

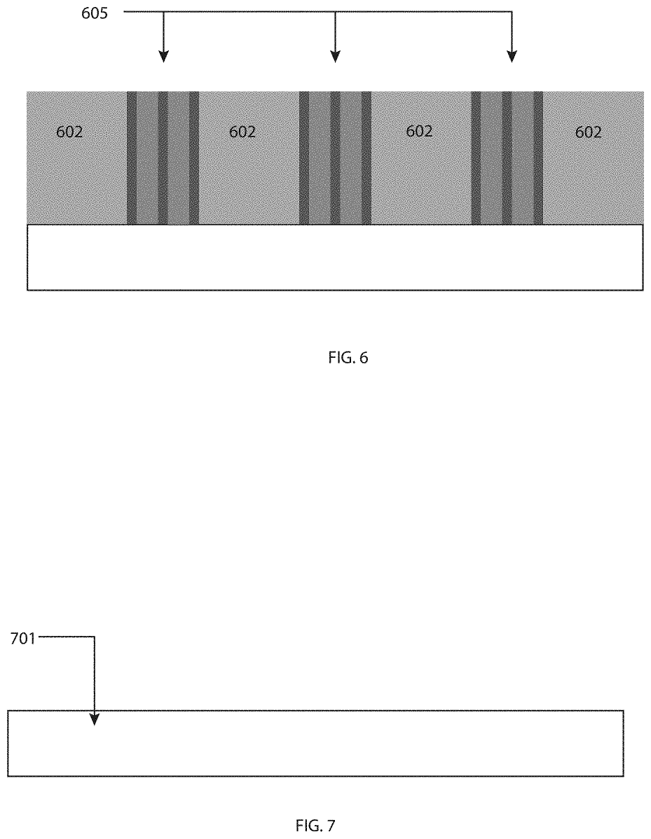

However, the copper pillars need not be etched out as leaving in copper can promote the formation of stronger eddy currents and act as magnetic shielding, although both of which are typically undesirable for magnetic cores, this may have some benefit in limited applications. FIG. 6 shows the copper pillars 602 left between cores 605.

There are at least three additional modes of creating pillars for the present invention. In the first additional mode, the medium is a dry film, and the pillars are patterned by light. In the second additional mode, the medium is epoxy plastic, and the pillars are patterned by laser drilling. In the third additional mode, the medium is epoxy plastic, and the pillars are patterned by a chemical etching process, for example, wet etching.

FIG. 7 denoted the initial state of the first additional mode. A semiconductor device 701, typically a wafer, forms the base.

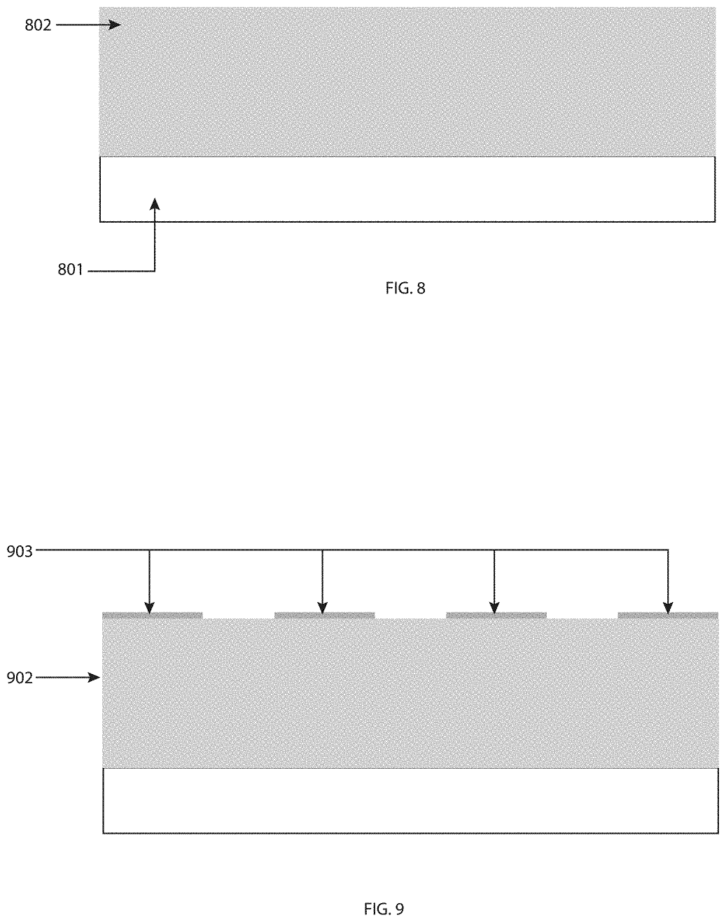

FIG. 8 denotes the initial step of the first additional mode. Here a dry film 802 has been placed on the semiconductor device 801 in preparation for the patterning process.

As shown in FIG. 9, a patterning process is begun. A series of plating slits 903 are defined. The plating slits 903 will become slits in the dry film 902, in which the magnetic core layers will be plated.

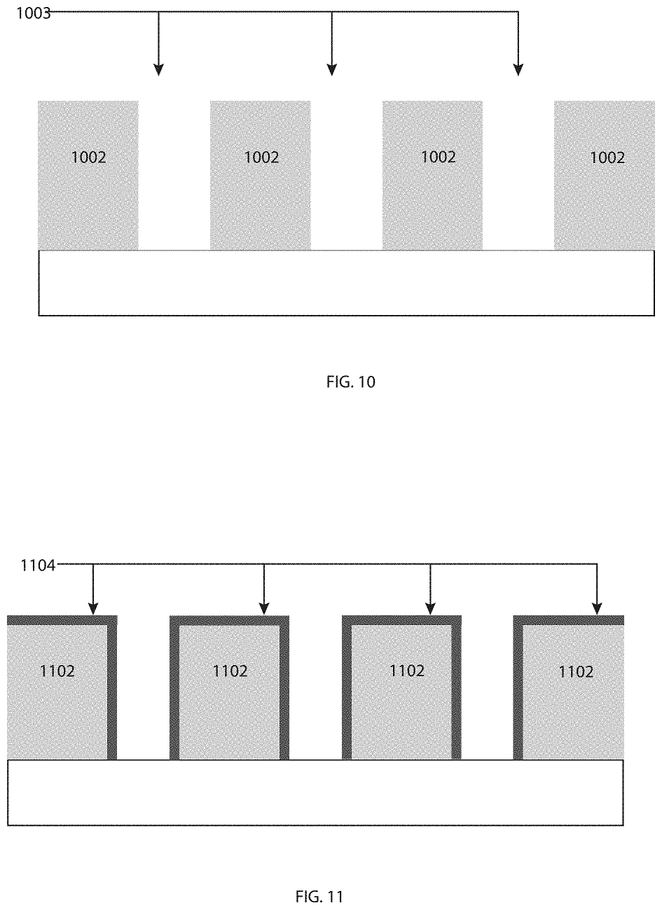

As shown in FIG. 10, the patterning of the plating slits has resulted in a series of slits 1003 between dry film pillars 1002. The dry film pillar 1002 will remain throughout the majority of the plating process.

As shown in FIG. 11, a first core layer 1104 is plated onto the dry film pillars 1102. The first core layer 1104 will cover the sides and the tops of the dry film pillars 1102. The edges of the dry film pillars 1102 are extremely straight, having been defined by light, and this straightness will translate to the vertical portions of the first core layer 1104 and any subsequent core layers plated onto the first core layer 1104.

In a single-layer core, the first core layer may be the only core layer plated, but its thickness may be increased so that it fills the slits. Although this increase in thickness is not strictly necessary as multiple thinner cores could be plated at once by not filling in the slit.

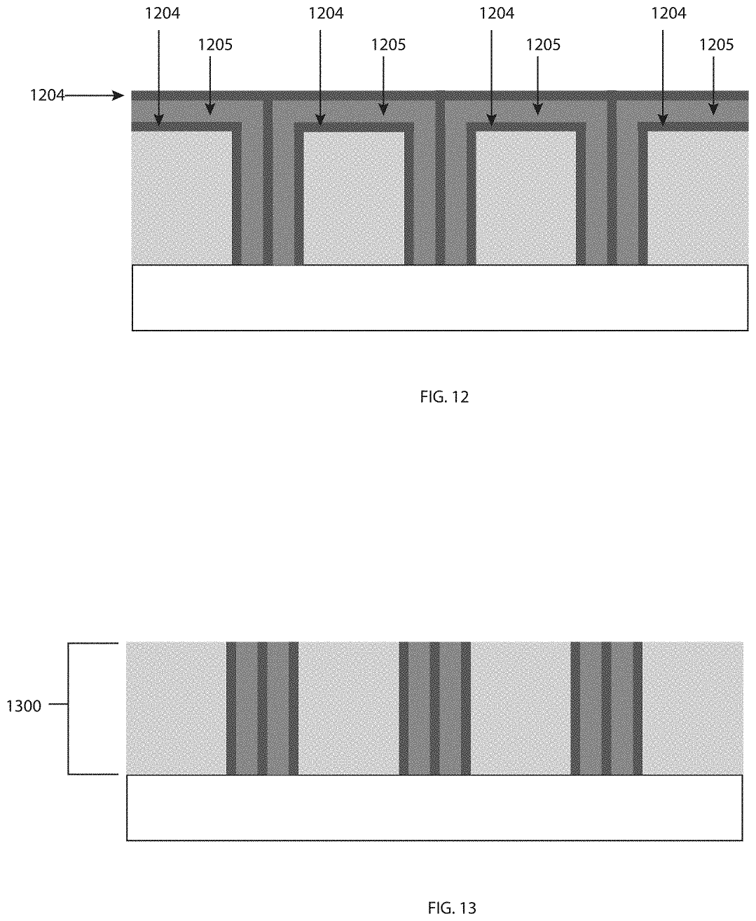

As shown in FIG. 12, in the case of multi-layer cores, multiple layers can be plated on the dry film pillars 1202. Here the magnetic core to be made has multiple layers where a first material 1204 and second material 1205 alternating materials serve as layers. The sequence and variety of materials and the number of layers may change to better suit an intended design purpose for the magnetic core. This preferred embodiment excels at making nickel-iron-based multi-layer cores.

Once the materials are plated, as shown in FIG. 12, everything is ground down to a level surface, which results in the dry film forming the level structure 1300, as shown in FIG. 13. The dry film can be removed, and thus a series of straight magnetic cores have been produced for a low cost.

In the second and third modes, the preferred medium is epoxy plastic, and as such, the initial patterning methods are changed to suit the medium.

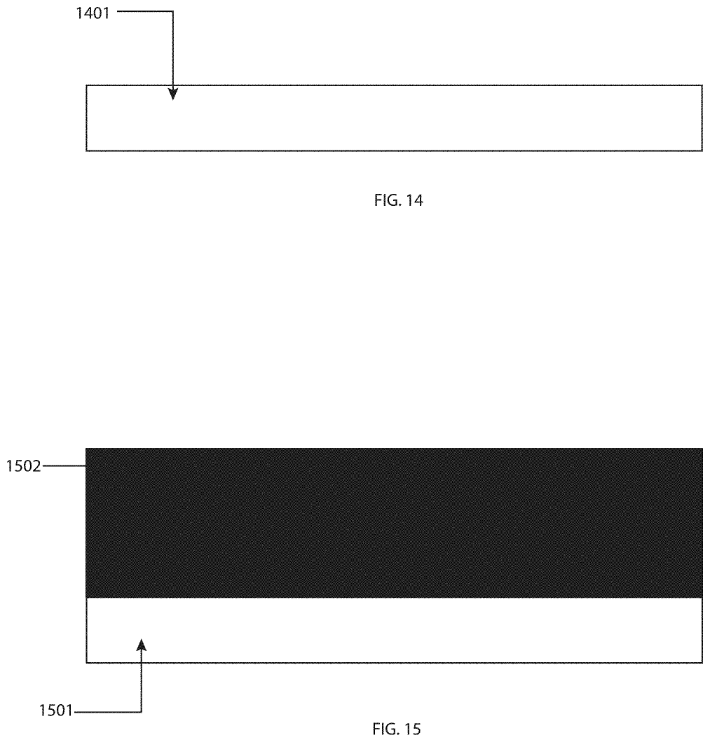

The initial starting condition may be the same in the second and third additional modes, as shown in FIG. 14, where 1401 denotes a semiconductor device or wafer.

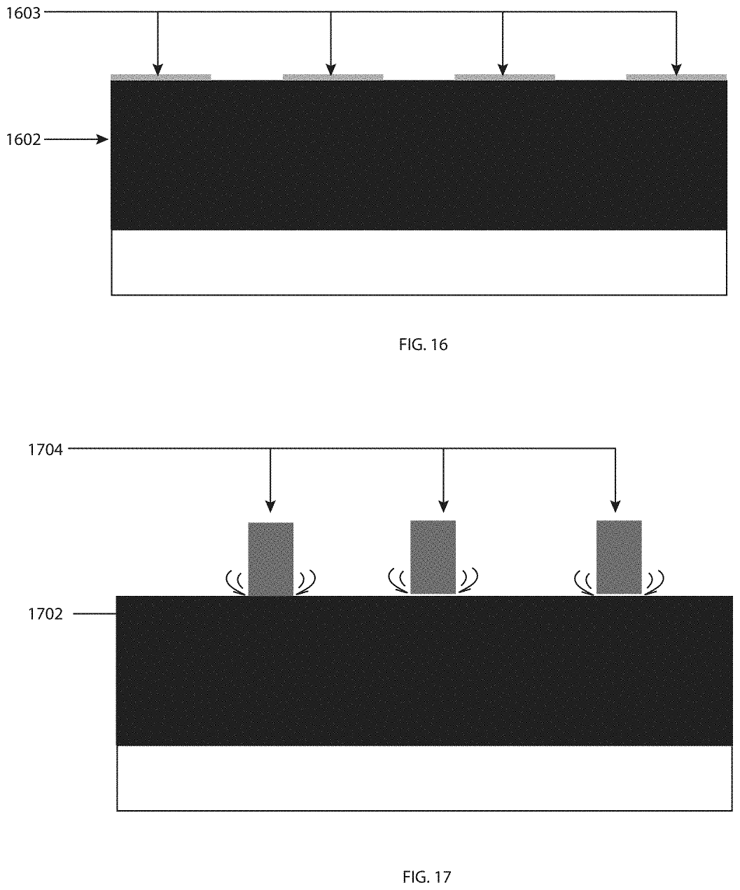

As shown in FIG. 15, in the initial step of the second and third additional modes, an epoxy plastic 1502 is placed onto the semiconductor device or wafer 1501. This is in preparation for the patterning process, which will differentiate the second and third modes.

The second additional mode's method of patterning is shown in FIG. 16, where a computer-generated laser drilling pattern 1603 is present. FIG. 17 shows laser drills 1704 drilling a series of slits into the semiconductor plastic 1702. The laser drilling provides a straight vertical surface that will translate to a later plated magnetic core.

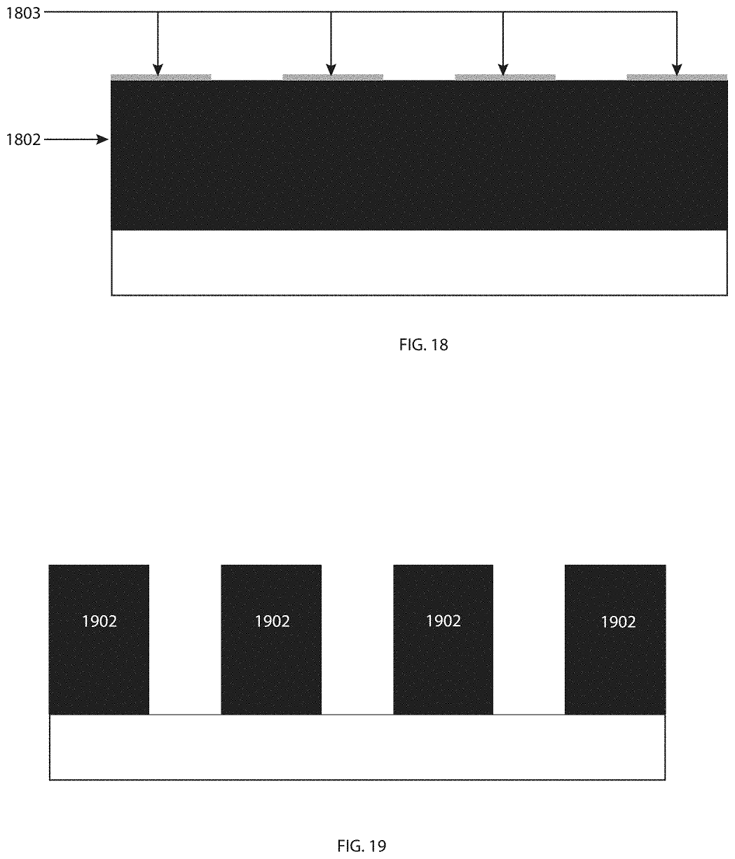

The third additional mode's method of patterning is shown in FIG. 18, where a chemical etch has been prepared by patterning and etching pattern for a series of plating slits on the epoxy plastic 1802. These plating slits will become the slits 1903 shown in FIG. 19.

In the second and third additional modes, once the series of slits has been created in the epoxy plastic, forming pillars, these embodiments follow the same process to form the magnetic core.

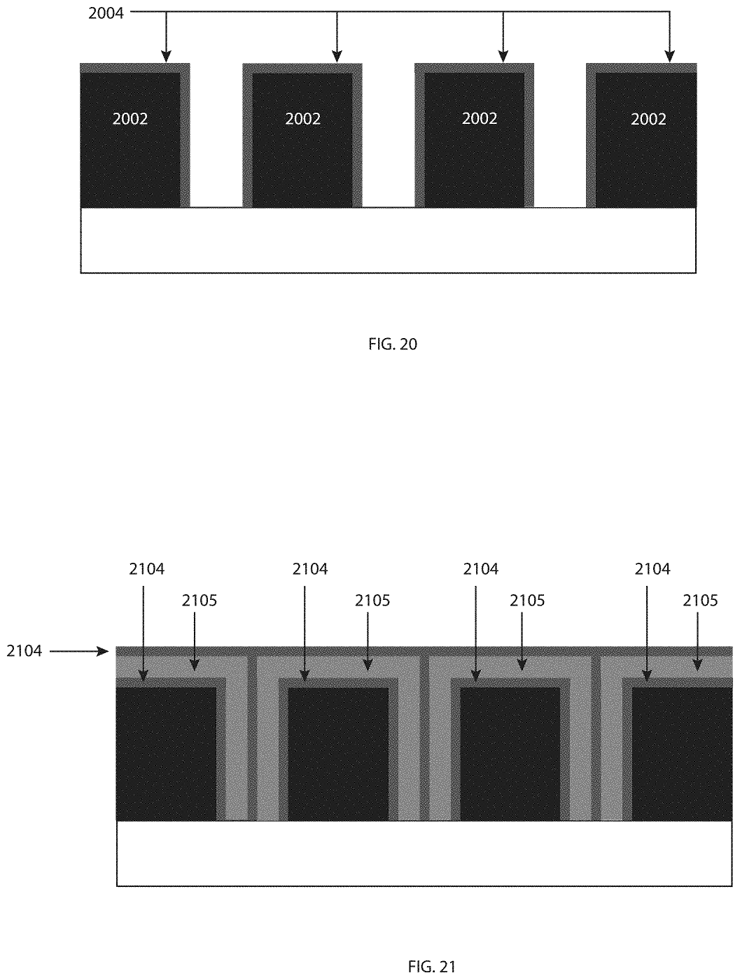

Thus, for both the second and third additional modes, as shown in FIG. 20, a first core layer 2004 is plated onto the epoxy plastic pillars 2002. The first core layer 2004 will cover the sides and the tops of the epoxy plastic pillars 2002. The edges of the epoxy plastic pillars 2002, in the case of the second embodiment, are very straight, having been defined by the laser. But, in the third embodiment, the edges of the epoxy plastic pillars 2002 are less straight due to the chemical etching process, although still usable. In either case, the straightness of the epoxy plastic pillars' vertical edges will translate to the vertical portions of the first core layer 2004 and any subsequent core layers plated onto the first core layer 2004.

As shown in FIG. 21, in the case of multi-layer cores, multiple layers can be plated on the epoxy plastic pillars 2102. Here the magnetic core to be made has multiple layers where a first material 2104 and second material 2105 alternating materials serve as layers. The sequence and variety of materials, and the number of layers, may change to better suit an intended design purpose for the magnetic core.

Once the materials are plated, as shown in FIG. 20, the structure is ground down to present a level surface that exposes the epoxy plastic pillars forming the level structure 2100, as shown in FIG. 21. The epoxy plastic pillars can be removed or replaced if desired. Thus, a series of straight magnetic cores have been produced for a low cost.

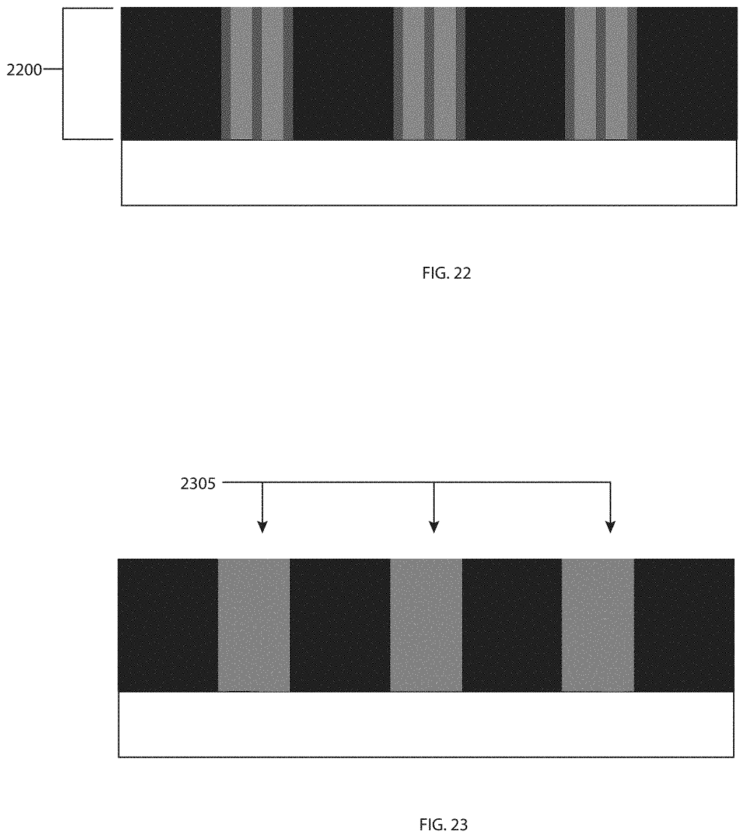

As shown by FIG. 22, a single-layer core may also be built by the embodiments of the present invention. These single-layer cores 2205 will take up the vertical roughness of the method used to create the pillars while presenting an upper surface roughness derived from the grinding process.

The cores of the present invention may be any such material plateable and suitable for use in cores, including nickel-iron and silica particulate layered cores created by CCVD process.

Embodiments include but are not limited to:
(Embodiment 1) A method of producing straight magnetic core elements by vertical plating comprising:
   Placing a dry film onto a wafer or device,
   Patterning a series of plating slits into the dry film,
   Exposing the series of plating slits in the dry film, creating a series of slits,
   Plating a first core layer into the series of slits; and
   Grinding the first core layer to create a level surface with the dry film.
(Embodiment 2) A method of producing straight magnetic core elements by vertical plating comprising:
   Placing an epoxy plastic onto a wafer or device,
   Laser drilling a series of plating slits into the epoxy plastic,
   Plating a first core layer into the series of slits; and
   Grinding the first core layer to create a level surface with the epoxy plastic.
(Embodiment 3) A method of producing straight magnetic core elements by vertical plating comprising:
   Patterning an etching pattern for a series of plating slits onto an epoxy plastic,
   Etching the etching pattern to create a series of slits;
   Plating a first core layer into the series of slits; and
   Grinding the first core layer to create a level surface with the epoxy plastic.
(Embodiment 4) A method of producing straight magnetic core elements by vertical plating comprising:
   Plating a series of pillars onto a carrier,
   Plating a first core layer onto the surface of the pillars; and
   Grinding the first core layer to create a level surface with the pillars.
(Embodiment 5) The method of producing straight magnetic core elements in vertical plating of embodiment 1, 2, 3, or 4, further comprising plating of a second core layer composed of a different material than the first core material onto the first core material and then grinding the second core layer to create a level surface with the pillar.
(Embodiment 6) The method of embodiment 4, further comprises plating a subsequent core layer of material matching the first core layer and repeating the plating of the second and subsequent layers of core material until the desired thickness of the core is reached and then grinding all core layers until a level surface with the pillars are formed.

The metals plated may be suitable for standard electroplating and may be plated using any method of electroplating, such as Duty Cycle Plating which is ideal for creating small cores. The spacing of the copper pillars will determine the initial size of the magnetic core being plated until the pillars are removed. These pillars enable small cores to be well supported as they are supported against the initial plating surface and two copper pillars, which reduces the risk of structural malfunction during manufacturing. The number of pillars may be odd or even but should be more than one. After the creation of pillars, the plating process is interchangeable between all modes of plating.

The drawings and figures show multiple embodiments and are intended to be descriptive of particular embodiments but not limited with regards to the scope or number, or style of the embodiments of the invention. The invention may incorporate a myriad of styles and particular embodiments. All figures are prototypes and rough drawings: the final products may be more refined by one skill in the art. Nothing should be construed as critical or essential unless explicitly described as such. Also, the articles “a” and “an” may be understood as “one or more.” Where only one item is intended, the term “one” or other similar language is used. Also, the terms “has,” “have,” “having,” or the like are intended to be open-ended terms.

I claim:

1. A method of producing straight magnetic core elements in vertical plating, comprising:
Creating a series of pillars on the surface of a carrier, the pillars of the series having a height equal to the width of a magnetic core to be formed and being spaced according to the height of the magnetic core to be formed;
Plating at least one core layer on the upper and side surfaces of the pillars in the series; and
Grinding off the core layers on the upper surface of the pillars forming a series of cores.

2. The method producing straight magnetic core elements in vertical plating of claim 2, wherein the creation of a series of pillars comprises, plating up pillars on a carrier.

3. The method of producing straight magnetic core elements in vertical plating of claim 2, wherein there are at least two layers of core material plated.

4. The method of producing straight magnetic core elements in vertical plating of claim 3, wherein each subsequent layer of core material plated is an alternate core material than the immediately previous layer plated.

5. The method of producing straight magnetic core elements in vertical plating of claim 4, wherein the core layers alternate between a nickel-iron core layer and a silica particulate layer.

6. The method producing straight magnetic core elements in vertical plating of claim 1, wherein the creation of a series of pillars comprises, (i) placing a substrate onto a wafer; (ii) patterning a series of slits according to the shape of the substrate; and (iii) creating in the substrate a series of slits producing pillars according to the pattern, creating a slitted substrate.

7. The method of producing straight magnetic core elements in vertical plating of claim 6, wherein the substrate is a dry film.

8. The method of producing straight magnetic core elements in vertical plating of claim 7, wherein the patterning is a dry film patterning.

9. The method of producing straight magnetic core elements in vertical plating of claim 8, wherein the creation of slits is achieved by dry film etching.

10. The method of producing straight magnetic core elements in vertical plating of claim 9, wherein there are at least two layers of core material plated.

11. The method of producing straight magnetic core elements in vertical plating of claim 6, wherein the substrate is an epoxy plastic.

12. The method of producing straight magnetic core elements in vertical plating of claim 11, wherein the patterning is a computer-generated laser drilling pattern.

13. The method of producing straight magnetic core elements in vertical plating of claim 12, wherein the epoxy plastic is drilled by a laser.

14. The method of producing straight magnetic core elements in vertical plating of claim 13, wherein there are at least two layers of core material plated.

15. The method of producing straight magnetic core elements in vertical plating of claim 11, wherein the style of the pattern is a chemical etch pattern.

16. The method of producing straight magnetic core elements in vertical plating of claim 15, wherein creating the series of slits occurs by a chemical etch.

17. The method of producing straight magnetic core elements in vertical plating of claim 16 wherein there are at least two layers of core material plated.

18. The method of producing straight magnetic core elements in vertical plating of claim 1 wherein there are at least two layers of core material plated.

19. The method of producing straight magnetic core elements in vertical plating of claim 12 wherein each subsequent layer of core material plated is an alternate core material than the immediately previous layer plated.

20. The method of producing straight magnetic core elements in vertical plating of claim 13 wherein the core layers alternate between a nickel-iron core layer and a silica particulate layer.
